(19) United States
(12) Patent Application Publication
(10) Pub. No.: US 2006/0193356 A1
(43) Pub. Date: Aug. 31, 2006

(54) Die level optical transduction systems

(76) Inventors: Robert Osiander, Ellicott City, MD (US); Andreas G. Andreou, Baltimore, MD (US); Francisco Tejada, Miami, FL (US); Danielle M. Wesolek, Washington, DC (US); Joseph A. Miragliotta, Ellicott City, MD (US); Philippe O. Pouliquen, Baltimore, MD (US); Dennis K. Wickenden, Woodbine, MD (US)

Correspondence Address: THE JOHNS HOPKINS UNIVERSITYAPPLIED PHYSICS LABORA;OFFICE OF PATENT COUNSEL, 11100 JOHNS HOPKINS ROAD, MAIL STOP 7-156, LAUREL, MD, 20723-6099, US

(21) Appl. No.: 11/333,498

(22) Filed: Jan. 17, 2006

Related U.S. Application Data
(60) Provisional application No. 60/644,662, filed on Jan. 18, 2005.

(51) Int. Cl. H01S 3/00; G01B 9/02

(52) U.S. Cl. 372/38.01; 356/450

(57) ABSTRACT

A scalable architecture based in silicon on sapphire (SOS) CMOS for building an interferometric optical detection system to sense the motion of a resonating MEMS device or to detect the motion of any object to which the system is packaged. The SOS CMOS device is packaged with both vertical cavity surface emitting lasers (VCSELs) and MEMS devices. The optical transparency of the sapphire substrate together with the ultra thin silicon PIN photodiodes available in the SOS process allows for the design of both a Michelson-type and Fabry-Perot-type interferometer. The detectors, signal processing electronics and VCSEL drivers are built on the SOS CMOS for a complete system.

### CROSS-REFERENCE TO RELATED APPLICATIONS

This application claims the benefit of United States Provisional Application No. 60/644,662, filed Jan. 18, 2005, the entire contents of which are hereby incorporated by reference as if fully set forth herein, under 35 U.S.C. §119(e).

### BACKGROUND OF THE INVENTION

1. Field of the Invention

The present invention relates to transduction systems and, more specifically, to die level optical transduction systems based in silicon on insulator CMOS processes for displacement measurements.

2. Background

The performance of microelectromechanical sensor systems (MEMS) relies critically on the transduction method employed to convert the mechanical displacement into an electrical signal. Measuring mechanical displacement in MEMS through capacitive readout techniques is the industry standard and is employed in many commercially available devices. However, sensing motion through capacitive sense techniques has several limitations, the most pronounced of which is the need to add surface area to the mechanical structure to add parallel plate capacitance via the incorporation of capacitive sensing fingers. This is contrary to the steady reduction of device size to increase the resonance frequencies of the mechanical structures. For piezoelectric sensing, specialized materials need to be incorporated into the MEMS fabrication process.

Optical readout techniques have distinct advantages over more traditional capacitive and piezoelectric transduction methods. Optical techniques are employed in applications where atomic resolution is necessary, for example scanning probe microscopes. Optical detection methods allow for the design of simple and optimized mechanical structures not hampered by the need for increased surface area or special material layers. The only requirement for optical detection is an optically reflective area. In addition, optical detection methods can also provide a much higher sensitivity, about 3 orders of magnitude. Typically optical detection methods are not compatible with standard MEMS and microelectronics processing and have only been built in special optic devices which are assembled piece by piece.

An optical Michelson-type interferometer detection scheme has been reported using a bulk CMOS technology for an optical microphone application. The disadvantage with implementing the Michelson in a bulk process is that to achieve a die level solution one needs to fabricate through substrate holes on the received bulk CMOS die. Also the light source can not be easily integrated onto and controlled by the bulk CMOS die.

What is needed, therefore, is an optical transduction system that can be applied to a broad range of fields where displacement measurement is needed. The new system has to be capable of implementation in a commercial CMOS process, thereby allowing for easy integration of the light source, signal processing elements, and the device whose motion is to be sensed without the need for specially built parts and more complex packing.

### SUMMARY OF INVENTION

The invention is a scalable architecture based in silicon on sapphire (SOS) CMOS for building an interferometric optical detection system and is the first such system to be implemented in a commercial CMOS process. As such the invention offers easier integration than other similar optical readout architectures including providing for all signal processing to be performed on the same chip as the sensing photodetector. Most other similar optical sensing methods require a specially fabricated photodetector. The invention also allows for the easy integration of the light source due to the ability to pass the laser light through the sapphire substrate. Unlike other optical sensing methods that require specially fabricated parts to be packaged individually, the invention requires only three parts, the light source, the SOS CMOS and the device whose motion is to be sensed, which can be packaged on the wafer level.

In general the invention is an integrated die level optical transduction system comprising: a composite substrate comprising a thin layer of silicon on a transparent, insulating substrate; at least one electronic device fabricated in the thin layer of silicon; at least one photodetector in the thin layer of silicon placed to build the desired detection system; at least one light source; and at least one movable device, that is, a device of which the displacement is to be measured, aligned under the light source to reflect light back towards the photodetector in the thin layer of silicon.

The new detection system of the invention is currently being applied to sense the motion of a resonating MEMS device, but can be used to detect the motion of any object to which the system is integrated.

In a current embodiment, the SOS CMOS device is integrated with both vertical cavity surface emitting lasers (VCSELs) and MEMS devices. The optical transparency of the sapphire substrate together with the ultra thin silicon PIN photodiodes available in this SOS process allows for the design of both a Michelson-type and Fabry-Perot-type interferometer. The detectors, signal processing electronics and VCSEL drivers are built on the SOS CMOS for a complete system.

The invention relies on the optical transparency of a substrate such as in the Peregrine Semiconductor Corp., San Diego, Calif., SOS CMOS technology. The substrate allows light from a light source to be transmitted through to a second layer of moveable structures. The light is then reflected back to the SOS CMOS die where it is detected with PIN photodiodes available for fabrication in this process.

In one embodiment the invention is a hybrid device, which uses a vertical cavity surface emitting laser (VCSEL) as the light source. The VCSEL is flip-chip bonded onto bondpads on the SOS CMOS device. This combined part is then bonded to the device layer of a MEMS or other movable object. An intermediate layer can be used for the inclusion of optical elements such as lenses, or diffraction gratings. Alternatively, these structures can be fabricated on the back of the SOS CMOS die.

The SOS CMOS device layer contains all the necessary electronics including but not limited to photodiodes, amplifiers, VCSEL drivers, VCSEL power output stabilization circuits and Analog to Digital converters. Analog and digital CMOS circuits can be used for a wide range of signal processing. The SOS CMOS electronics can be connected to the VCSEL and MEMS via bondpads for feedback control.

In one implementation of the embodiment, a Fabry-Perot-type interferometer is constructed to measure vertical deflections of a moving device. This implementation relies on the thickness of the PIN photodiode available from the 100 nm thick active silicon layer in the Peregrine SOS CMOS process. When the proper wavelength of light is sent through the thin PIN photodiode and is reflected back into the photodiode a standing wave is produced. The intensity of the standing wave is dependent on the position of the MEMS or other movable device. The light intensity absorbed in the photodiode allows determination of the position of the device.

Another implementation of this embodiment is a Michelson-type interferometer. This implementation relies on the interference created by two beams from the same light source that travel different path lengths and then recombine to create an interference pattern. In this arrangement, a diffraction grating is patterned onto the sapphire substrate which acts as a beam splitter. As the device moves, the path difference changes between the two beams interfering at the photodiode, the beam diffracted at the grating and the beam reflected at the device and diffracted at the grating, which causes an intensity change and therefore a signal change in the photodiodes. Again the light intensity allows the determination of the position of the device.

In alternative embodiment an optical package is constructed comprising the light source and lenses, filters and other optical components as needed. The optical package is then bonded to the SOS CMOS device rather than the light source being bonded directly to the SOS CMOS device.

### BRIEF DESCRIPTION OF THE DRAWINGS

Various embodiments are described below with reference to the drawings.

FIG. 1, consisting of FIGS. 1A and 1B, illustrates, respectively, cross-sectional views of a Fabry-Perot-type interferometer embodiment of the invention and of a Michelson-type interferometer embodiment of the invention.

FIG. 2 is a cross-sectional view of a Fabry-Perot-type interferometer embodiment of the invention with multiple SOS die stacked with photodiodes on each layer for directional information.

FIG. 3 illustrates the design of a PIN diode for the Fabry-Perot-type interferometer embodiment of the invention.

FIG. 4 illustrates an example of a photodiode amplifier design for use in the invention.

FIG. 5 illustrates, in block form, a generalize light source driver feedback circuit;

FIG. 6 illustrates one specific embodiment of a light source driver feedback circuit for use in the invention.

FIG. 7 illustrates an embodiment of the invention comprising an array of light sources.

FIG. 8 illustrates an embodiment of the invention using a single light source with a large beam width wherein the beam is collimated and passed through an optical masking plate to create the same effect as an array.

FIG. 9, consisting of FIGS. 9A and 9B, illustrates, respectively, a normal and exploded view of the optical package component of the invention.

### DETAILED DESCRIPTION OF THE PREFERRED EMBODIMENT(S)

An optical transduction system uses optical means to measure the motion of a device and convert it into an electrical signal. The die level optical transduction systems of the invention are built using a combination of commercial parts and custom designed CMOS integrated circuits. The CMOS circuits are designed and fabricated in any appropriate silicon on insulator technology (SOI). The SOI technology needs to provide a thin silicon layer and a substrate that is either transparent or has been etched to allow for laser radiation to pass through it. Peregrine Semiconductor Corp., San Diego, Calif., offers such a SOI CMOS process.

Peregrine Semiconductor's CMOS process fabricates circuits in an ultra-thin 100 nm silicon layer on a sapphire substrate. In addition to having CMOS transistors and other standard passive components, the Peregrine Semiconductor silicon on sapphire (SOS) process allows for the fabrication of PIN photodiodes. The thickness of the silicon and optical transparency of the substrate are essential to the setup of the optical transduction system which can be used to measure the motion or displacement of any device or object to which it is packaged. However, as noted above, instead of a transparent substrate, the invention could be fabricated by etching away the substrate to create hole(s) for the light source. Furthermore, while the 100 nm silicon layer on a sapphire substrate used by Peregrine Semiconductor is used in one embodiment of the invention, any silicon on insulator technology can be used which has an appropriate silicon thickness.

The optical transduction system can have a number of implementations known from macroscopic applications. One example is to measure displacement by optical beam deflection. In this setup the light source would be reflected off a moving device and into an array of two or more diodes where the distribution of the reflected light or the position of the reflected spot can be used to determine the deflection of the device. An example application is the measurement of the deflection of a cantilever beam at resonance. Another implementation would be an imager which images the motion of a device or follows the spot from a beam deflection setup.

An alternative implementation could be a photodiode, diode array, or imager, which would measure the intensity of the light returned from an object that is moving laterally and reflects different amounts of light depending on its position and the position of the light source, detector, and additional shades.

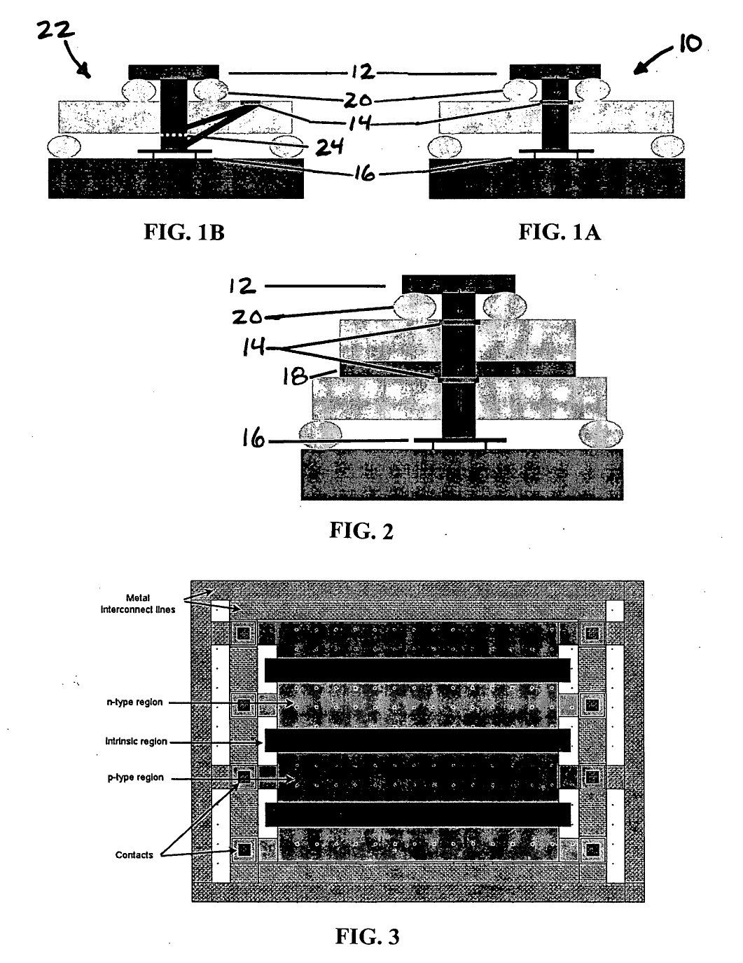

Another optical transduction system of interest is an interferometer. In interferometers, the original beam and a reflected beam are combined to create optical interference which can be detected electronically in a photodiode. A description of two types of interferometers follows; other interferometers are possible as well. Note, in the description that follows as illustrated in FIGS. 1A, 1B, 2, 7, and 8 what appear to be vertical openings in the SOS die are not, in fact, openings but are placed in the figures to illustrate the light path through the die.

One implementation of this technology is in the form of a Fabry-Perot-type interferometer 10 as shown in FIG. 1 A. This approach relies on the thickness of the PIN photodiode available in the SOS CMOS process and the way it is designed. When the proper wavelength of light from a light source 12, e.g., a vertical cavity surface emitting laser (VCSEL), is sent through, for example, a 100 nm silicon PIN photodiode 14 and is reflected back by a movable device 16 into the photodiode a standing wave is produced. The intensity of the standing wave is dependent on the position of the movable device which will alter the phase relation between the incoming and reflected waves. The light intensity absorbed in the photodiode allows the determination of the displacement of the device.

The Fabry-Perot-type interferometer embodiment of the invention can also have multiple SOS die stacked with photodiodes 14 on each layer as shown in FIG. 2. If a spacer 18 between the SOS die is sized properly, then the phase angle difference between the two interfering beams can be determined and from this the direction of the deflection can also be determined. One spacing that works well is spacing, n, between the photodiodes of n(λ/4), where λ is the wavelength of the light.

The design of the PIN diode for the Fabry-Perot interferometer is important. Due to the thin silicon layers the PIN diode is made by laterally placing p doped, intrinsic and n doped areas next to each other and repeating until the desired size of the diode is reached. In most diodes the p and n doped silicon would be covered with contacts for electrical connection to a metal interconnect layer in the CMOS process. These metal lines inside the photodiode form a grating which could interfere with and possibly destroy the standing wave. One solution is to keep the contacts to the p and n doped regions at the periphery of the diode (FIG. 3).

A second implementation of the technology is a Michelson-type interferometer 22 as shown in FIG. 1B. This approach relies on the interference created by two beams split from the same light source 12 that travel different path lengths and are recombined. In this arrangement, a diffraction grating 24 is patterned onto the sapphire substrate 26, the grating acting as a beam splitter. As the movable device 16 is displaced, the path length difference changes between the beam diffracted from the grating and the beam reflected from the movable device and diffracted at the grating. Therefore the intensity at the photodiode, where the two beam combine and interfere changes, which causes a signal change in the photodiode 14. Again the light intensity allows the determination of the displacement of the device. Since there are multiple diffraction orders, the intensity change can be observed in all orders, given that no two orders fall onto the same photodiode.

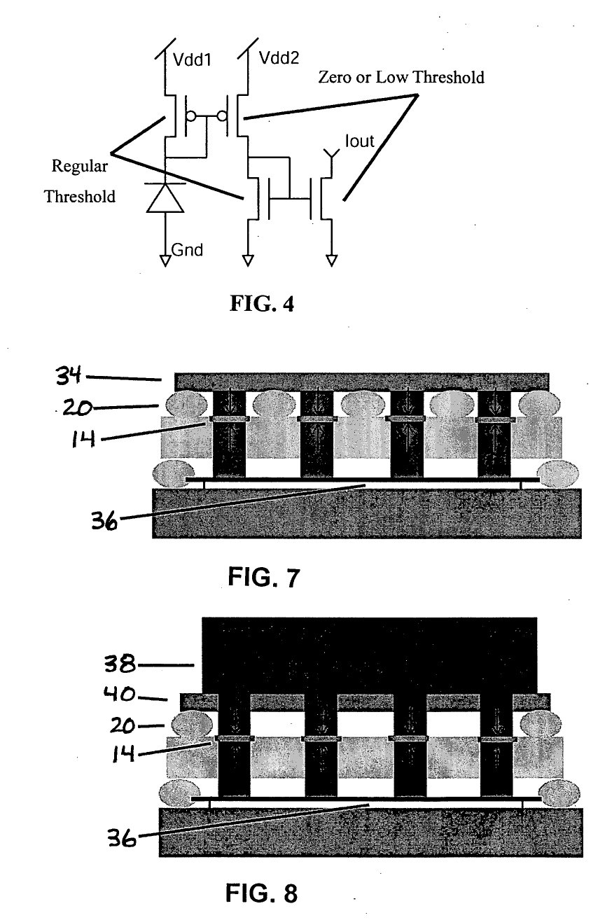

In order to build the die level optical deflection detection system several components are necessary. First is the custom built SOS CMOS die. The die must be designed with the proper placement of photodiodes, support electronics and interface connections. The SOS CMOS device layer contains all the necessary electronics including but not limited to photodiodes, amplifiers, VCSEL drivers with power stabilization, and Analog to Digital converters. An example of the photodiode amplifier is a simple current mirror whose output transistor has a lower threshold then the input transistor which provides gain as shown in FIG. 4.

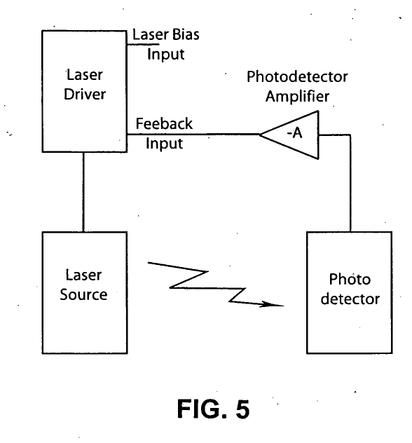

As shown in FIG. 5, a light source (e.g., laser) driver feedback can be implemented by using a photodetector (e.g., PIN photodiode) in the optical path to sense the power output. In the Fabry-Perot-type interferometer this can be the same diode used to sense motion and in the Michelson-type interferometer it can be an extra diode put in the laser path.

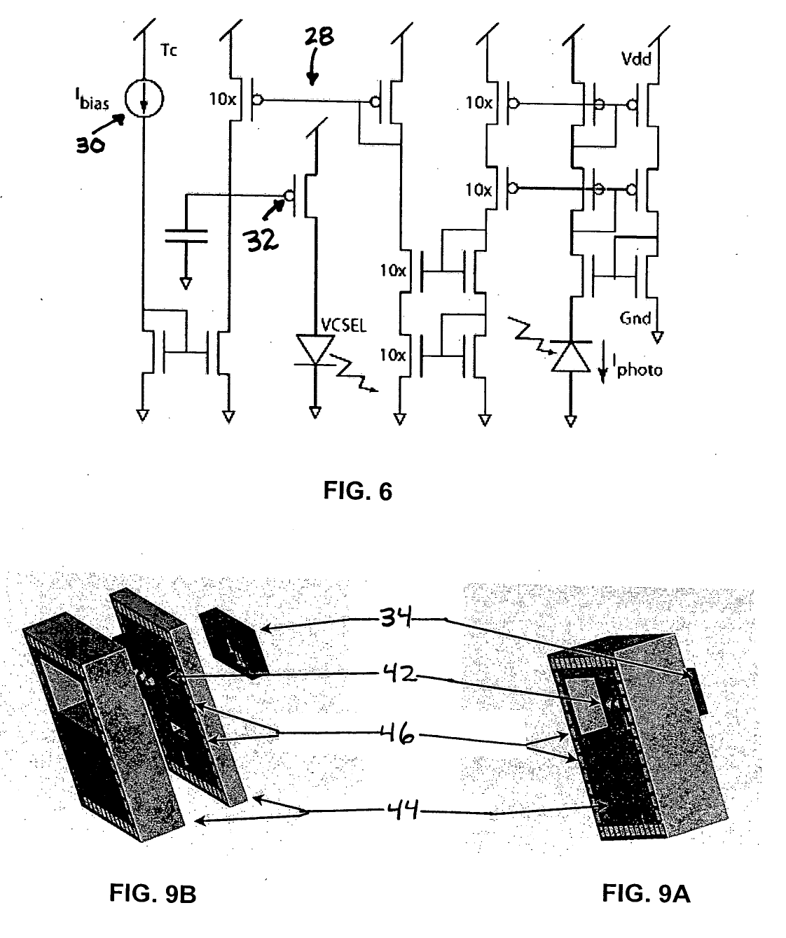

Any power output changes from the light source generate noise in the optical detection system. As shown in FIG. 6, in one specific embodiment the feedback circuit uses negative feedback to stabilize the light source power output. The circuit uses at least one current mirror 28 to amplify the output of the photodiode to levels comparable to the light source (e.g. VCSEL) driving current. There is a bias current input 30 to the circuit which allows the user to set the light source current. The feedback current from the photodiode has a negative feedback such that when the photodiode current increases, the drive current for the light source decreases and vice versa. There is a time constant node 32 which can be used to set the frequency response of the circuit to the photodiode input. This will allow for the light source noise to be removed but will stop the feedback circuit from responding to the photodiode current changes due to the motion of the device under test. This circuit will stabilize the light source power output which should reduce noise in the systems and, therefore, give a lower noise floor than previously possible.

Analog and digital CMOS circuits can be used for a wide range of signal processing depending on the application. The SOS CMOS electronics can be electrically connected to the VCSEL and the movable device via bond pads for feedback control. Once the design is fabricated by Peregrine Semiconductor it is packaged together with the other components of the die level optical interferometer using flip chip bonding to complete the system. See gold ball bonds 20 in FIGS. 1A, 1B, 2, 7, and 8. When bonding the different components together and there is an array of light sources, an array of photodetectors, and an array of movable devices, (and, in addition, in one embodiment an optical masking layer) the pitch or spacing between elements in each array needs to match the spacing in the other arrays such that the elements in the arrays line up. As one simple example, if a 1×4 VCSEL array has four lasers with the laser apertures on a 250 micron pitch (or spacing) then the photodiodes and movable devices must match that pitch (or spacing).

The second major component of the detection system is the light source. Any light source which has the proper wavelength can be used. For applications such as the imager or beam deflection setup a light emitting diode (LED) could be used. For the interferometer applications where a coherent light source is needed a laser can be used. An external laser can be used as the source but this has the limit of being large. Also a more standard semiconductor laser could be used but packaging would be difficult and the size would be limited due to the laser device. The current and most compact setup uses a vertical cavity surface emitting laser (VCSEL) as the laser source. The VCSEL has been chosen as the current light source due to its small size and ease of integration. It is possible to flip chip bond a VCSEL to the SOS die wherever necessary to build the interferometer.

VCSELs 34 (FIG. 7) are available in both singles and arrays. This allows for an arrayed readout from a single large device, such as a microphone diaphragm, or for the readout of an array of small devices, such as a phase array of microphones or magnetometers, (either single large device or array of small devices indicated by numeral 36 in FIGS. 7 and 8) as shown in FIG. 7. VCSEL arrays are also useful for making differential measurements. Two neighboring VCSELs could differentially read out the deflection of the two times of a MEMS tuning fork being used as a gyroscope.

As an alternative to using a VCSEL array for a large device or an array of smaller devices as shown in FIG. 7, a single light source can be used. As shown in FIG. 8, if the beam of a single light source is collimated 38 and the beam width is significantly large, the beam can be sent through an optical masking plate 40 which only allows light to pass where the plate allows producing multiple light sources. The optical masking plate can be fabricated or built out of one of the CMOS metal interconnection layers.

In another embodiment, instead of bonding the VCSEL directly to the SOS CMOS device, an optical package is bonded to the SOS CMOS device. The optical package will have the VCSEL bonded to it and have as many layers as necessary for optical components 42, such as lenses, polarization optics, filters, etc.

As shown in FIGS. 9A and 9B, the optical package can be built using stacked layers 44 of low temperature co-fired ceramics. These layers are assembled to give precise spacing between the VCSEL and the optical components. Currently, the ceramic used is about 100 microns thick per layer. The top layer has metal patterns on it which route the VCSEL electrical connections 46 to the edge of the part. All of the layers below the top have electrical vias which allow the VCSEL connections to be passed down to the SOS CMOS device. Along with electrical connections it is necessary to provide an optical path for the laser light. A high power laser is used to cut holes in the ceramic for this purpose. The holes are made larger to accommodate the placement of optical component such as a lenses, collimating or focusing optics etc., while smaller holes are used to merely pass light. This allows for the stacking of multiple optical components in the light path.

Each ceramic layer is fabricated on the wafer scale. Then the wafers are stacked and fired to produce a single piece of ceramic with the proper holes and electrical contacts. The combined wafers are then diced to produce many optical packages. An alternate fabrication method would use bulk micromachined silicon instead of the ceramics to build the optical package.

As noted, the optical package allows for lenses, polarization filters and other optical components to be integrated into the optical path of the interferometer before the light passes through the detector. When bonding the VCSEL directly to the SOS CMOS part this is not possible. The optical package fabrication is flexible enough to allow for as many or as few optical components to be incorporated easily.

Furthermore, the optical package makes it possible to collimate the laser light before it passes through the SOS CMOS part. Collimated light yields less interference between neighboring arrayed interferometers and gives better response from the interferometer because the incident and reflected light waves have closer intensities and beam widths.

Finally, the optical package also makes it possible to include a ¼ wave plate into the optical path which allows for two neighboring interferometers to be used together to obtain the phase information for the two interfering beams and from that information the direction of the displacement. Currently, the interferometer only gives displacement magnitude, not directional information.

The last component of the interferometer is the movable device. This device can be any object with a surface that is reflective or which can be made to reflect a beam e.g. via diffraction at the correct wavelength.. The integrated device consisting of the VCSEL and the SOS die will need to be packaged to the substrate containing the movable device in a way that the beam is reflected back into the integrated device, and the package does not interfere with the motion of the device. The combined integrated VCSEL SOS device can be flip chip bonded to the substrate or die containing the movable device. See gold ball bonds 20 in FIGS. 1A, 1B, 2, 7, and 8. The movable device can be, but is not limited to, MEMS devices such as a gyroscope, accelerometers, magnetometers, and pressure sensors, atomic force microscopy tips, neural probes, protein manipulation probes, etc.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. An integrated die level optical transduction system comprising:
a composite substrate comprising a thin layer of silicon on a transparent, insulating substrate;
at least one electronic device fabricated in the thin layer of silicon;
at least one photodetector in the thin layer of silicon placed to build the desired detection system;
at least one light source; and
at least one movable device aligned under the light source to reflect light back towards the photodetector in the thin layer of silicon.

2. An integrated die level optical transduction system according to claim 1, wherein the photodetector comprises a photodiode.

3. An integrated die level optical transduction system according to claim 1, wherein the photodetector comprises a PIN photodiode.

4. An integrated die level optical transduction system according to claim 1, wherein the photodetector comprises a phototransistor.

5. An integrated die level optical transduction system according to claim 1, wherein the photodetector comprises a plurality of metal interconnections, the plurality of metal interconnections being placed only at the periphery of the photodetector.

6. An integrated die level optical transduction system according to claim 1, further comprising a current mirror with different threshold transistors for providing gain to amplify the photodetector signal.

7. An integrated die level optical transduction system according to claim 1, further comprising a circuit for using the photodetector signal to provide feedback into the light source driver for power stabilization.

8. An integrated die level optical transduction system according to claim 7, wherein the light source comprises a vertical cavity surface emitting laser (VCSEL) and the feedback circuit comprises:
at least one current mirror for amplifying the photodetector output to levels comparable to the VCSEL driver current;
a bias current input for setting the VCSEL driver current, wherein when the photodetector current increases, the VCSEL driver current decreases and vice versa; and
a time constant node for setting the frequency response of the VCSEL driver current to the photodetector input, thereby allowing noise from the VCSEL driver to be removed while stopping the feedback circuit from responding to the changes in photodetector current due to the motion of the movable device.

9. An integrated die level optical transduction system according to claim 1, wherein the light source comprises a light emitting diode (LED).

10. An integrated die level optical transduction system according to claim 1, wherein the light source comprises a laser.

11. An integrated die level optical transduction system according to claim 1, wherein the light source comprises a semiconductor laser.

12. An integrated die level optical transduction system according to claim 1, wherein the light source comprises a vertical cavity surface emitting laser (VCSEL).

13. An integrated die level optical transduction system according to claim 1, wherein the light source comprises a vertical cavity surface emitting laser (VCSEL) array; the photodetector comprises an array of photodiodes; and the movable device is as large as each of the VCSEL and photodiode arrays.

14. An integrated die level optical transduction system according to claim 13, wherein the array of photodiodes is an imager.

15. An integrated die level optical transduction system according to claim 1, wherein the light source comprises a vertical cavity surface emitting laser (VCSEL) array; the photodetector comprises an array of photodiodes matched to the pitch of the VCSEL array; and the movable device comprises an array matched to the pitch of the VCSEL array.

16. An integrated die level optical transduction system according to claim 15, wherein the array of photodiodes is an imager.

17. An integrated die level optical transduction system according to claim 1, further comprising an optical masking layer for producing an array of multiple light sources and wherein the light source comprises a single collimated light source for passing through the optical masking layer to produce the multiple light sources; the photodetector comprises an array of photodiodes; and wherein the movable device is as large as the array of multiple light sources.

18. An integrated die level optical transduction system according to claim 17, wherein the array of photodiodes is an imager.

19. An integrated die level optical transduction system according to claim 1, further comprising an optical masking layer for producing an array of multiple light sources and wherein the light source comprises a single collimated light source for passing through the optical masking layer to produce the multiple light sources; the photodetector comprises an array of photodiodes matched to the pitch of the array of multiple light sources; and the movable device comprises an array of movable devices matched to the pitch of the array of multiple light sources.

20. An integrated die level optical transduction system according to claim 19, wherein the array of photodiodes is an imager.

21. An integrated die level optical transduction system according to claim 1, wherein the transparent, insulating substrate comprises sapphire.

22. An integrated die level optical transduction system according to claim 1, wherein the light source comprises a VCSEL, wherein the VCSEL is flip-chip bonded to the composite substrate with a plurality of gold ball bonds.

23. An integrated die level optical transduction system according to claim 1, wherein the movable device comprises a microelectromechanical system (MEMS) device.

24. An integrated die level optical transduction system according to claim 1, wherein the optical detection system comprises an interferometer.

25. An integrated die level optical interferometer according to claim 24, wherein the photodetector comprises a PIN photodiode and the light source comprises a laser, wherein the PIN photodiode is placed in the laser path to form a Fabry-Perot Interferometer.

26. An integrated die level optical interferometer according to claim 24, wherein the photodetector comprises a PIN photodiode and the light source comprises a laser, the system further comprising at least two composite substrates each substrate having a PIN photodiode the substrates being stacked such that the PIN photodiodes are at a spacing, n, of n(λ4), wherein λ is the wavelength of the laser, and are aligned and placed in the laser path to form a Fabry-Perot Interferometer.

27. An integrated die level optical interferometer according to claim 24, wherein the photodetector comprises a PIN photodiode and the light source comprises a laser, wherein the PIN photodiode is placed to the side of the laser path, the system further comprising a diffraction grating patterned on the side of the composite substrate opposite the laser and in the laser path to form a Michelson Interferometer.

28. An integrated die level optical transduction system according to claim 1, wherein the system measures the motion of the movable device.

29. An integrated die level optical transduction system according to claim 1, wherein the photodetector comprises an array of photodiodes for imaging.

30. An integrated die level optical transduction system according to claim 1, further comprising at least one layer bonded to the composite substrate having an optical component.

31. An integrated die level optical transduction system according to claim 1, further comprising a layer having an optical component, wherein the light source is bonded to the layer and the layer is bonded to the composite substrate.

32. An integrated die level optical transduction system according to claim 30, wherein the light source comprises a VCSEL.

33. An integrated die level optical transduction system according to claim 30, wherein the layer comprises a ceramic layer.

34. An integrated die level optical transduction system constructed as an interferometer for measuring mechanical displacement comprising:
a composite substrate comprising a thin layer of silicon on an optically transparent, insulating substrate and further comprising:
at least one electronic device fabricated in the thin layer of silicon; and
at least one photodiode fabricated in the thin layer of silicon;
a light source bonded to a first side of the composite substrate; and
a movable device bonded to a second side of the composite substrate;
wherein light from the light source is transmitted through the photodiode and reflected back into the photodiode by the movable device thereby producing a standing wave the intensity of which allows determination of the displacement of the movable device.

35. An integrated die level optical transduction system constructed as an interferometer for measuring mechanical displacement comprising:
a composite substrate comprising a thin layer of silicon on an optically transparent, insulating substrate and further comprising:
at least one electronic device fabricated in the thin layer of silicon;
at least one photodiode fabricated in the thin layer of silicon; and
a diffraction grating patterned onto a second side of the substrate;
a light source bonded to a first side of the composite substrate; and
a movable device bonded to a second side of the composite substrate;
wherein light from the light source is transmitted through the photodiode and split by the diffraction grating into two beams, a first beam reflected back into the photodiode by the diffraction grating and a second beam reflected back into the photodiode by the movable device thereby producing a path length difference between the first and second beams, the path length difference changing as the movable device changes position, thereby causing a change in the light intensity in the photodiode, the change in intensity allowing determination of the displacement of the movable device.
